(19) United States
(12) Patent Application Publication
(10) Pub. No.: US 2019/0242455 A1
(43) Pub. Date: Aug. 8, 2019

(54) CONNECTOR FOR CONVEYOR BELTS

(71) Applicant: Volodymyr KOVALCHUK, (US)

(72) Inventor: Volodymyr KOVALCHUK, Odessa (UA)

(21) Appl. No.: 16/093,589

(22) PCT Filed: Apr. 13, 2017
(86) PCT No.: PCT/UA2017/000042

§ 371 Date: Apr. 17, 2019

(30) Foreign Application Priority Data
Apr. 15, 2016 (UA) A 2016 04184

(51) Int. Cl. F16G 3/08

(52) U.S. Cl. CPC F16G 3/08

(57) ABSTRACT

A connector for conveyor belts includes, installed on both sides of a conveyor belt, a pair of plates having protrusions on the inner surface thereof, which are tightened by a bolt and nut and by a removable elastic ring capable of being secured on the body of the bolt. In the present embodiment, one plate is provided with a polygonal through-hole having a mounting seat for the head of the bolt, which bolt has a securing portion below the head thereof, the securing portion corresponding to the polygonal hole, and the other plate is provided with a mounting seat for the nut, which nut is carried out with a slot on an end thereof. In certain embodiments, the bolt head is flat, the bolt shank is conical, and the nut is hexagonal. The plates may have through-holes disposed between the protrusions on the inner surfaces of the plates.

The invention relates to a transport technology, in particular, to a transport conveyor, namely to a closed type belt conveyors, which are used in the food industry, for the transport of grain, their products, and can be.

For connection of conveyor belts used mechanical connectors. Feature compound conveyor belts closed type is that the connector plate fixed coupling element, namely the bolt and the nut, wherein the nut is screwed onto the bolt. Such a connection method determines the structure of mechanical joints, which differ from the mechanical fasteners for conveyor belts open type.

A device for connecting the rubber-belt, comprising mounted on both sides of the conveyor belts a pair of plates, each of which has protrusions on the inner surfaces of the plates, which is strapped bolt with a nut, the bolt head is rigidly connected to the plate (Ukraine patent for utility model 56254 ” device for joining the edges of the fabric conveyor belt «STING», F16G 3/00, publ. 10.01.201 1, Bul. JV <_1).

The disadvantages of such a connector is the shortening of the conveyor operation due to accelerated failure of the scrapers, brushes and the conveyor rolls by the action of protruding above the surface of the running plate conveyor belt heads of bolts and nuts, and the complexity and considerable time of installation work due to lack of fixation plates with the bolt in relation to the conveyor belt at the time of its installation in the closed-type conveyors, which affects the time of installation and ease of execution.

The basis of the invention is to improve the mechanical connector structure for conveyor belts by changing the hole configuration in a single wafer, the execution in the other plate through the bolt hole, the changes of the bolt design and use an elastic ring that provides the securing bolt in the plate and fixing, plate relative to the conveyor belt, thereby increasing the life of the conveyor belt and provides the convenience of work.

The problem is solved by a connector for conveyor belts comprising ma ted on both sides of the conveyor belts a pair of plates, each of which has protrusions on the inner surfaces of the plates, tightness bolt and nut according to the invention, a single plate provided with a through polygonal opening with a mounting slot the bolt head, the bolt has a head fixing portion formed corresponding to the through polygonal hole, the other plate has a bearing seat for the nut formed with a slot at the end, and further comprising a removable resilient ring arranged to fix it to the body of the bolt.

In some cases, through holes with a mounting socket for the bolt head are made quadrangular. It is better when the bolt head is flat,

Furthermore, the bolt shank is formed as cone-like.

Furthermore, additional plates have through holes disposed between the projections. In some cases, the nut has a hexagonal shape.

Performing plate connector for conveyor belts with continuous polygonal, in particular quadrangular, opening and having a bolt head fixing portion formed corresponding to the through hole in the plate provides a fixed position of the bolt in the hole when winding the nut onto the bolt, eliminates the “rotation of the bolt” during clamping conveyor belt, and a removable resilient ring allows quickly lock bolt installation plate with a bolt on the conveyor belt and securely hold the bottom plate by in relative conveyor belt, which simplifies the installation of the connector, to reduce the time of work, eliminate destruction of the conveyor belt and thus extend the period of its operation.

Performing on the plate receiving hole under the nut and use a nut with a slot at the end, makes it possible to place it in the slot and reduce the protruding part of the connector on the running surface lining of the conveyor belt and thus prevent damage to scrapers and brushes, and to increase the service life of the conveyor.

Performing a flat head screw bolt which can accommodate a bearing seat plate on the lower side of the conveyor flush with the surface of the plate, which minimizes the influence of the protruding above the surface of the electrode suspension conveyor belt connector element for the life of the conveyor belts.

Performance of a tapered shank of the bolt allowing to put the nut on the bolt during connector assembly freely and quickly, which further provides the convenience of work.

Running through openings between the projections inner surfaces of the plates for added strength in the joint gap and can accommodate the connector plate in coated conveyor belt, which prevents failure of the scrapers and brushes and thus increases the lifetime of the conveyor.

Performing hexagonal nut can be used during installation of the connector widely used hexagonal wrench, which allows for easy execution of works without a special wrench.

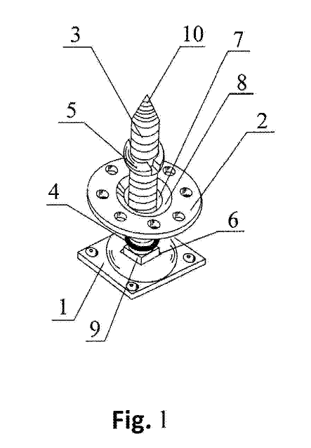

FIG. 1 is a perspective view of a connector for conveyor belts.

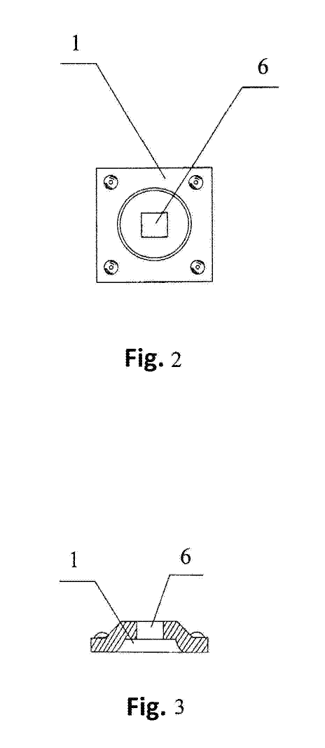

FIG. 2 shows a top view of the bottom plate of the connector for conveyor belts.

FIG. 3 is a side view of the bottom plate of the connector for conveyor belts.

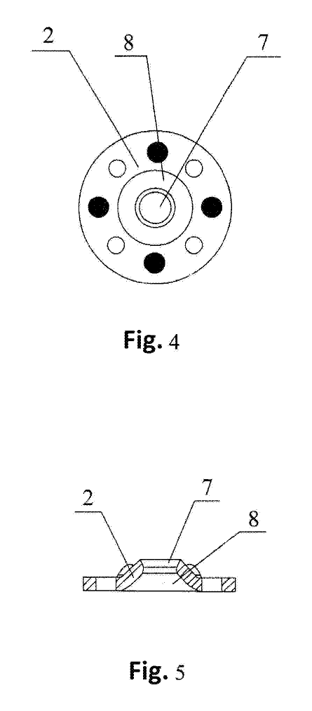

FIG. 4 shows a top view of the top plate of the connector for conveyor belts.

FIG. 5 is a side view of the top plate of the connector for conveyor belts.

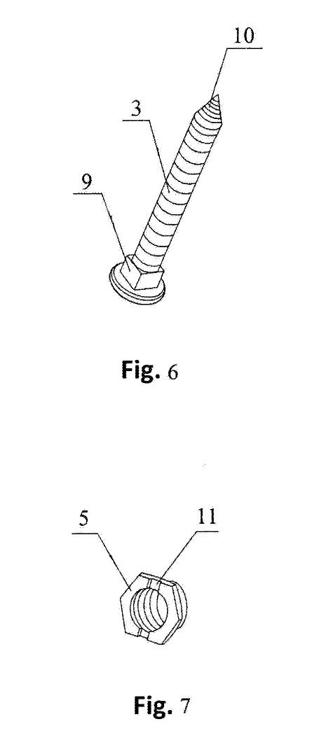

FIG. 6 shows the connector bolt for conveyor belts.

FIG. 7 illustrates the connector nut for conveyor belts.

The drawings d the description of the implementation and use of the connector for conveyor belts in no way limit the scope set forth in the claims, but merely illustrate the essence of the invention.

Connector for conveyor belts consists of a lower plate and upper plate 2, bolt 3, the elastic ring nut 4 and 5.

The bottom plate 1 is formed with a through hole 6 polygonal (quadrangular in this case) bolt 3. The upper plate 2 is formed with a through hole 7 with a seat 8 for the nut 5. The bolt has a head fixing portion 9, in this case quadrangular cross section, which corresponds quadrangular through hole 6 in the bottom plate, and a tapered shank 10.

The elastic ring 4 has an internal diameter, whose size enables easily and securely fix it to the body of the bolt 3 and the nut 5 has a slot 11 at the end of a special spanner. The nut may be made hexagonal shape (FIG. 7), allowing during assembly using a simple hex wrench.

Lower plate 1 and upper plate 2 is formed with protrusions on the inner surfaces of the plates and may have through holes between the projections.

Compound Conveyor belts closed type connector is as follows.

Rubber-belt portion is folded so that cut edges are superposed one on one. On the inner plate of the conveyor belt and mark out holes are punched. Quadrangular locking portion of each bolt has a correspond rectangular holes in the bottom plate, the lower surface of the head of the bolt abuts the surface of the receiving hole, so that the upper flat surface of the bolt head does not protrude above the surface of the plate. Below each opening in the belt is inserted a bolt previously wound into the hole of the bottom plate. Thereafter, a bolt wear elastic ring which holds the plate on the conveyor belt with a bolt. On the outer lining of the conveyor belt superimposed upper plate, so that a bolt passed through the hole of the upper plate.

The proposed connector for conveyor belts can quickly and conveniently make the connection conveyor belts gated and provide increased service life of rubber bands.

1. A connector for conveyor belts, including a pair of plates mounted on both sides of the conveyor belt, each of which has protrusions on the inner surface of the plates, tightened with a bolt and nut, characterized in that a through-hole polygonal hole with a socket for the bolt head the bolt under the head has a fixing part, made corresponding to a through polygonal hole, the other plate has a mounting seat under the nut, which is made with a slot on the end and additionally includes there is a removable elastic ring made with the possibility of its fixation on the body of the bolt.

2. Connector for conveyor belts according to claim 1, characterized in that the through hole with a landing slot for the bolt head is made quadrangular.

3. Connector for conveyor belts according to claim 1, characterized in that the bolt head is made flat.

4. Connector for conveyor belts according to claim 1, characterized in that the shank of the bolt is tapered.

5. Connector for conveyor belts according to claim 1, characterized in that the plates additionally have through holes located between the protrusions.

6. Connector for conveyor according to claim 1, characterized in that the nut has a hexagonal shape.
